(19) United States
(12) Patent Application Publication
(10) Pub. No.: US 2025/0315896 A1
(43) Pub. Date: Oct. 9, 2025

(54) Machine Learning Systems and Methods for Automatic Generation of Rebuild Estimates

(71) Applicant: Xactware Solutions, Inc., Lehi, UT (US)

(72) Inventor: Zeke S. Smith, Spanish Fork, UT (US)

(73) Assignee: Xactware Solutions, Inc., Lehi, UT (US)

(21) Appl. No.: 19/169,613

(22) Filed: Apr. 3, 2025

Related U.S. Application Data
(60) Provisional application No. 63/573,578, filed on Apr. 3, 2024.

(51) Int. Cl. G06Q 40/08; G06F 8/20; G06Q 10/20; G06T 7/00

(52) U.S. Cl. CPC G06Q 40/08; G06F 8/20; G06Q 10/20; G06T 7/0002; G06T 2207/20081

(57) ABSTRACT

Machine learning systems and methods for automatic generation of rebuild estimates are provided. The system includes a data integration software layer which collects and pre-processes data generated from an insurance claims estimation software application; a machine learning (ML)/artificial intelligence (AI) software layer which extracts features from the data including details of damages, materials involved, labor costs, loss locations, and other information and trains and deploys one or more predictive machine learning models; a computer vision software layer which analyzes image or other visual data to detect, classify, and assess damage associated with a structure to be rebuilt; and an automated building estimate generation software layer which automatically generates a rebuild estimate for the structure using information generated by the data integration, ML/AI, and computer vision software layers.

### RELATED APPLICATIONS

This application claims priority to U.S. Provisional Patent Application Ser. No. 63/573,578 filed on Apr. 3, 2024, the entire disclosure of which is hereby expressly incorporated by reference

### BACKGROUND

### Technical Field

The present disclosure relates generally to the field of machine learning. More specifically, the present disclosure relates to machine learning systems and methods for automatic generation of rebuild estimates.

### Related Art

In the field of insurance mitigation and rebuilding estimation, the ability to enhance the accuracy, efficiency, and speed of generating “rebuild” estimates is a paramount concern. Rebuild estimates indicate the materials and costs associated with rebuilding an entire structure, or a portion of a structure, that has been damaged by an event, such as a natural disaster, weather, or other event. The current process of creating rebuild estimates is labor-intensive and time-consuming, and often involves manual input of items by insurance carrier adjusters. This leads to not only delays, but also increases the risk of error.

While various computer-based insurance claims and adjustment management software applications exist, such applications do not allow for the accurate, reliable, and automatic generation of rebuild estimates. Accordingly, what would be desirable, but have not yet been provided, are machine learning systems and methods for automatic generation of rebuild estimates which solve the foregoing and other needs.

### SUMMARY

The present disclosure relates to machine learning systems and methods for automatic generation of rebuild estimates. The system includes a data integration software layer which collects and pre-processes data generated from an insurance claims estimation software application; a machine learning (ML)/artificial intelligence (AI) software layer which extracts features from the data including details of damages, materials involved, labor costs, loss locations, and other information and trains and deploys one or more predictive machine learning models; a computer vision software layer which analyzes image or other visual data to detect, classify, and assess damage associated with a structure to be rebuilt; and an automated building estimate generation software layer which automatically generates a rebuild estimate for the structure using information generated by the data integration, ML/AI, and computer vision software layers.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating one configuration of the system of the present disclosure;

FIG. 2 is a diagram illustrating various software layers of one configuration of the system of the present disclosure;

FIG. 3 is sequence diagram illustrating processing steps carried out by, and communications between, the software layers illustrated in FIG. 2; and

FIG. 4 is diagram illustrating input data processed by the system and output data generated by the system.

### DETAILED DESCRIPTION

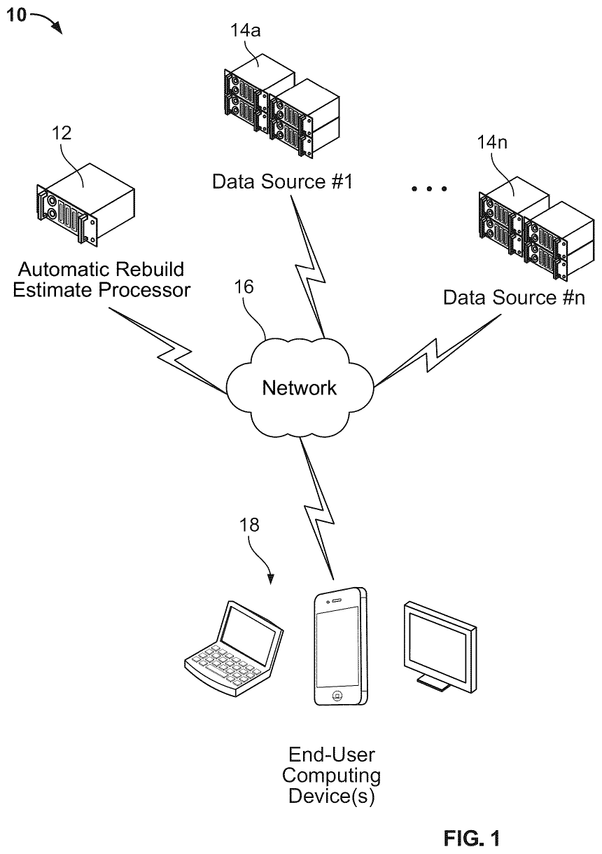

The present disclosure relates to machine learning systems and methods for automatic generation of rebuild estimates, as described in detail below in connection with FIGS. 1-4.

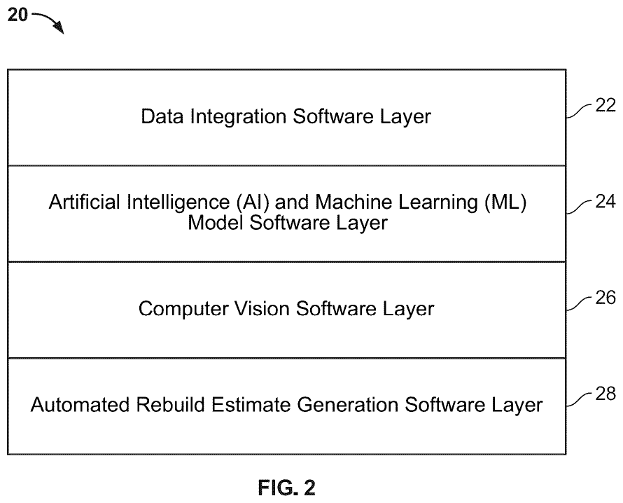

FIG. 1 is a diagram illustrating one configuration of the system of the present disclosure, indicated generally at 10. The system 10 includes an automatic rebuild estimate processor (computer system) 12 which is programmed to perform the various functions described herein. The processor 12 is in communication with one or more data source computer systems 14a-14n via a network 16, which could include a local area network (LAN), wide area network (WAN), an intranet, the Internet, a cellular data network, etc. The data source computer systems 14a-14n store information relating to insurance claims in connection with properties/structures that have been damaged and which require rebuilding. As will be described in more detail in connection with FIG. 2, the processor 12 is programmed to include and executes a plurality of software layers that, together, provide the functionality and features described herein. The processor 12 automatically generates rebuild estimates for properties/structures as described herein using insurance claims data obtained from the data source computer systems 14a-14n. The rebuild estimates could be accessed and/or displayed on one or more end-user computing devices 18, which could include, but are not limited to, laptop computers, desktop computers, smart phones, tablet computing devices, or any other suitable devices. The processor 12 could be a server, a cloud computing platform, or other suitable computing device programming in accordance with the present disclosure using any suitable high- or low-level programming language, including, but not limited to, C, C++, Java, Javascript, Python, or other suitable language. Such programming could be embodied as non-transitory, computer-readable instructions stored in a memory associated with the processor 12 (e.g., read-only memory (ROM), disk memory, flash memory, random-access memory (RAM), etc.) and executed by the processor 12.

FIG. 2 is a diagram illustrating various software layers of one configuration of the system of the present disclosure, indicated at 20. Such software layers 20 include a data integration software layer 22 which collects and pre-processes data generated from an insurance claims estimation software application; a machine learning (ML)/artificial intelligence (AI) software layer 24 which extracts features from the data including details of damages, materials involved, labor costs, loss locations, and other information and trains and deploys one or more predictive machine learning models; a computer vision software layer 26 which analyzes image or other visual data to detect, classify, and assess damage associated with a structure to be rebuilt; and an automated building estimate software generation layer 28 which automatically generates a rebuild estimate for the structure using information generated by the data integration, ML/AI, and computer vision software layers 22-26.

The data integration software layer 22 collects and pre-processes data generated from an insurance claims estimation software application. More specifically, the layer 22 receives a completed insurance claim adjustment assignment that could reside on an insurance carrier's computing system (e.g., one or more of the computer systems 14a-14n), as well as estimate data from a mitigation company's computing system (e.g., another of the computer systems 14a-14n) and historical data from previous claims relating to a subject property/structure to be rebuilt, using a data collection process executed by the processor 12. Additionally, the software layer 22 normalizes and pre-processes the data so that it is suitable for analysis and further processing by the layers 24-28. Such normalization and pre-processing includes, but is not limited to, data cleaning, handling missing values in the data, and converting the data into one or more formats suitable for further processing by the system.

The machine learning (ML)/artificial intelligence (AI) software layer 24 extracts features from the data including details of damages, materials involved, labor costs, loss locations, and other information and trains and deploys one or more predictive machine learning models. More specifically, the layer 24 extracts relevant features from an insurance adjustment (mitigation) estimate and related data such as the details of damages, materials involved, labor costs, loss locations, previous loss data, etc. Additionally, the layer 24 performs model training using historical data to train predictive models that can assess the relevance of one or more line items for possible inclusion in a rebuild estimate, as well as performing model deployment such that the trained models are deployed in order to make real-time predictions on new mitigation estimates. The layer 24 could be coded using suitable machine learning frameworks and associated programming languages including, but not limited to, TensorFlow and Pytorch to build, train, and deploy predictive models, and Scikit-learn to develop machine learning algorithms, perform feature engineering, and for data preprocessing.

The computer vision software layer 26 analyzes images or other visual data to detect, classify, and assess damage associated with a structure to be rebuilt. More specifically, the layer 26 performs object detection, classification, and damage assessment using computer vision applied to the images or other visual data. Additionally, the layer 26 performs image-to-text translation to convert the visual information into textual data that can be incorporated into a rebuild estimate. The layer 26 could be coded using suitable computer vision tools and associated programming languages including, but not limited to, OpenCV for image processing and computer vision tasks, as well as one or more pre-trained models such as VCG, ResNet, or other pre-trained models for image classification and object detection.

The automated building estimate generation software layer 28 automatically generates a rebuild estimate for the structure using information generated by the data integration, ML/AI, and computer vision software layers 22-26. More specifically, the layer 28 gathers and incorporates the data extracted and analyzed by the layers 22-26 into the rebuild estimate along with one or more predictions made by the AI/ML components of the layer 24 and any insights generated by the computer vision layer 26. Once the rebuild estimate is generated, the layer 28 transmits the estimate to an insurance carrier's claims processing software application (executing on one or more of the computer systems 14a-14n). Additionally, the layer 28 could execute a Robotic Process Automation (RPA) process to automate the process of creating and uploading the rebuild estimates, and/or one or more Application Programming Interfaces (APIs) or Software Development Kits (SDKs) could facilitate integration of the layer 28 with a carrier's claims processing software application or other third-party system.

It is noted that one or more of the layers 20 can additionally provide robust security measures to ensure data privacy and to comply with one or more relevant regulations such as GDPR, HIPAA, or other regulations. Additionally, the layers 20 could perform continuous monitoring and regular updates in order to ensure that the system is performing optimally, with proactive maintenance to adapt to changing requirements or data patterns.

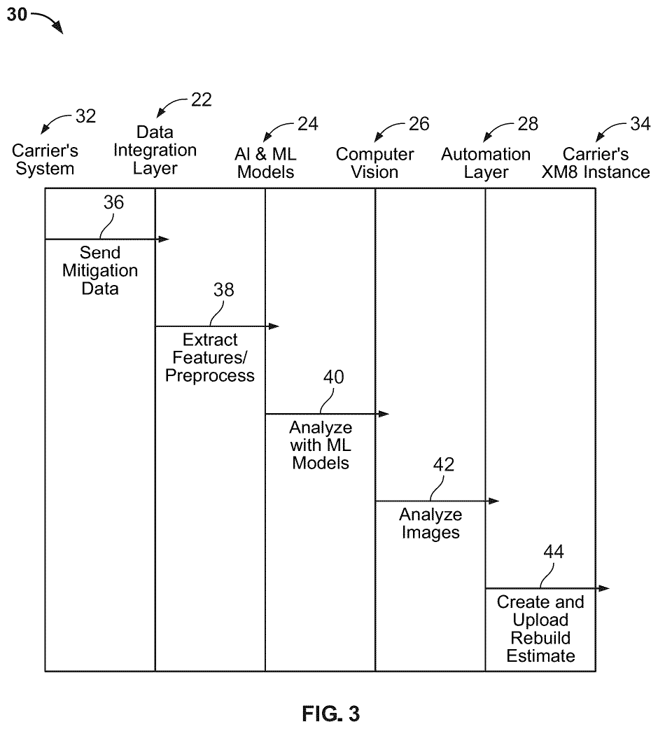

FIG. 3 is sequence diagram (indicated generally at 30) illustrating processing steps carried out by, and communications between, the software layers illustrated in FIG. 2. In step 36, the carrier's computer system (e.g., one or more of the computer systems 14a-14n) initiates the process by sending insurance claims information (e.g., mitigation information for mitigating damage at one or more properties) to the data integration layer 22. Then, in step 38, the layer 22 receives the data and performs feature extraction and preprocessing as discussed above in connection with FIG. 2, and transmits the extracted information to the AI/ML layer 24. Next, in step 40, the layer 24 analyzes the extracted information as discussed herein. Then, in step 42, the computer vision layer 256 processes any images related to the claim being processed in the manner discussed above in connection with FIG. 2. Finally, in step 44, the automation layer 28 creates the rebuild estimate and transmits it to the carrier's computer system 34 which could be one or more of the computing systems 14a-14n and which could execute an instance of an insurance claims estimation software application. In such circumstances, the claims estimation software application, receives the rebuild estimate and incorporates the same into the software application for use by a user of the claims estimation software application.

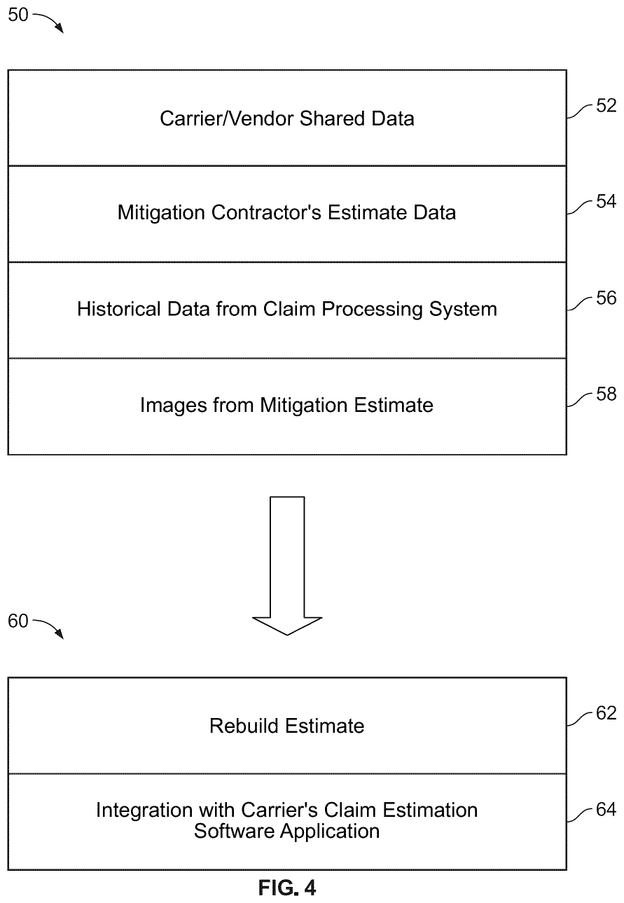

FIG. 4 is diagram illustrating input data processed by the system and output data generated by the system. The inputs 50 include the carrier or vendor's shared data 52, a mitigation contractor's estimate data 54, historical data 56 from the claims processing/estimate software application, and images 58 (e.g., from a claim/mitigation estimate). The outputs 60 generated by the system include the rebuild estimate 62 and one or more software integrations 64 with the carrier's claim estimation software application (e.g., by way of API calls/hooks, and/or SDK tools).

Advantageously, the system of the present disclosure employs AI, ML, and computer vision components in a software architecture that allows for automated creation of rebuild estimates. As a result, the system creates such estimates with improved speed and accuracy. Additionally, the system of highly scalable, in that each of the layers 20 can adapt to varying data volumes or business needs.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A machine learning system for automatically generating rebuild estimates, comprising:
a processor in communication with at least one data source via a network;
a data integration software layer executed by the processor, the data integration software layer collecting and pre-processing data generated by an insurance claims estimation software application;
an artificial intelligence (AI) software layer in communication with the data integration software layer and executed by the processor, the AI software layer extracting a plurality of features from the data collected and pre-processed by the data integration software layer;
a computer vision software layer executed by the processor, the computer vision software layer analyzing at least one image or visual data to detect, classify, and assess damage associated with a structure to be rebuilt; and
an automated building estimate generation software layer executed by the processor, the automated building estimate generation software layer automatically generating a rebuild estimate for the structure using information generated by the data integration software layer, the AI software layer, and the computer vision software layer.

2. The system of claim 1, wherein the data integration software layer receives a completed insurance claim adjustment assignment, estimate data, and historical claims data.

3. The system of claim 2, wherein the data integration software layer performing one or more of data cleaning, handling missing values, or converting formats for the completed insurance claim adjustment assignment, the estimate data, or the historical claims data.

4. The system of claim 1, wherein the plurality of features extracted by the AI software layer include one or more of damage details, materials, labor costs, or loss locations.

5. The system of claim 4, wherein the AI software layer trains and deploys one or more predictive machine learning models.

6. The system of claim 5, wherein the one or more predictive machine learning models assesses the relevance of one or more line items for potential inclusion in a rebuild estimate.

7. The system of claim 6, wherein the AI software layer deploys the one or more predictive machine learning models to make real-time predictions on new mitigation estimates.

8. The system of claim 1, wherein the computer vision software layer performs image-to-text translation to convert visual information into textual data.

9. The system of claim 8, wherein the computer vision software layer incorporates the textual data into a rebuild estimate.

10. The system of claim 1, wherein the automated building estimate generation software layer transmits the rebuild estimate to a claims processing software application.

11. The system of claim 10, wherein the automated building estimate generation software layer executes a robotic process automation (RPA) process to automate creation and uploading of the rebuild estimate.

12. The system of claim 10, wherein the automated building estimate generation software layer utilizes one or more Application Programming Interfaces (APIs) or Software Development Kits (SDKs) to integrate the automated building estimate generation software layer with a claims processing software application or a third-party system.

13. A machine learning method for automatically generating rebuild estimates, comprising:
collecting and pre-processing data generated by an insurance claims estimation software application using a data integration software layer executed by a processor;
extracting using an artificial intelligence (AI) software layer in communication with the data integration software layer and executed by the processor a plurality of features from the data collected and pre-processed by the data integration software layer;
analyzing at least one image or visual data using a computer visions software layer executed by the processor to detect, classify, and assess damage associated with a structure to be rebuilt; and
automatically generating by an automated building estimate generation software layer executed by the processor a rebuild estimate for the structure using information generated by the data integration software layer, the AI software layer, and the computer vision software layer.

14. The method of claim 13, further comprising receiving by the data integration software layer a completed insurance claim adjustment assignment, estimate data, and historical claims data.

15. The method of claim 14, further comprising performing by the data integration software layer one or more of data cleaning, handling missing values, or converting formats for the completed insurance claim adjustment assignment, the estimate data, or the historical claims data.

16. The method of claim 13, wherein the plurality of features extracted by the AI software layer include one or more of damage details, materials, labor costs, or loss locations.

17. The method of claim 16, further comprising training and deploying by the AI software layer one or more predictive machine learning models.

18. The method of claim 17, wherein the one or more predictive machine learning models assesses the relevance of one or more line items for potential inclusion in a rebuild estimate.

19. The method of claim 18, further comprising deploying by the AI software layer the one or more predictive machine learning models to make real-time predictions on new mitigation estimates.

20. The method of claim 13, further comprising performing by the computer vision software layer image-to-text translation to convert visual information into textual data.

21. The method of claim 20, further comprising incorporating by the computer vision software layer the textual data into a rebuild estimate.

22. The method of claim 13, further comprising transmitting by the automated building estimate generation software layer the rebuild estimate to a claims processing software application.

23. The method of claim 22, further comprising executing by the automated building estimate generation software layer a robotic process automation (RPA) process to automate creation and uploading of the rebuild estimate.

24. The method of claim 22, further comprising utilizing by the automated building estimate generation software layer one or more Application Programming Interfaces (APIs) or Software Development Kits (SDKs) to integrate the automated building estimate generation software layer with a claims processing software application or a third-party system.
